(19) United States
(12) Patent Application Publication
(10) Pub. No.: US 2015/0134387 A1
(43) Pub. Date: May 14, 2015

(54) OPTIMIZING INSPECTION AND MAINTENANCE OF COMPONENTS USING MOBILE DEVICE

(71) Applicant: Sharper Shape Ltd., Helsinki (FI)

(72) Inventors: Tero Heinonen, Helsinki (FI); Juha Hyyppa, Espoo (FI); Anttoni Jaakkola, Espoo (FI)

(21) Appl. No.: 14/535,234

(22) Filed: Nov. 6, 2014

Related U.S. Application Data
(60) Provisional application No. 61/901,495, filed on Nov. 8, 2013.

(51) Int. Cl. G06Q 10/06

(52) U.S. Cl. CPC G06Q 10/063112
USPC 705/7.14

(57) ABSTRACT

Disclosed is a system for reserving at least one work order using a mobile device with a map view. The system includes a receiving module, a processing module and a verification module. The receiving module is adapted to receive a request from the mobile device, the request satisfying at least one pre-defined criterion. The processing module is adapted to process the request satisfying the at least one pre-defined criterion by filtering a second set of work orders from a first set of work orders and enable the reservation of each selected work order from the second set of work orders for a pre-defined time period. The verification module is adapted to verify inspection of each site pertaining to the reserved work orders.

### CROSS-REFERENCE TO RELATED APPLICATIONS

This application claims priority to, and the benefit of, U.S. Provisional Patent Ser. No. 61/901,495, filed on 8 Nov. 2013, the disclosure of which is incorporated herein by reference in its entirety.

### TECHNICAL FIELD

The present disclosure relates to general area of the inspection and maintenance of components using a mobile device and, in particular, to a system and a method for reserving at least one work order for a component using a mobile device with a map view.

### BACKGROUND

Typically, a complete electric power supply system has three basic stages: generation, transmission and distribution of electricity. In the first stage, electricity is generated in power plants. Examples of the type of power plants can include a fossil fueled power plant, a nuclear power plant, a geothermal power plant, a solar power plant, wind based power plants, and the like. After electricity is generated, it is transmitted over distances using transmission lines. Transmission lines are constructed between transmissions substations located at electric generating stations. Transmission lines are supported overhead on towers or are underground. This power is carried through lines to distribution systems located in the local service territory.

The electricity generated at the power plants is transmitted and distributed to consumers using various components which include power generators, transformers, cables, switches, control units, circuits, transmission lines, sockets, and/or other suitable devices (and/or structures) in the electrical power supply system. These devices are installed at different places to supply electricity. For proper functioning and generating the maximum efficiency from these components, these components need to be inspected and maintenance activities from time to time. In addition, the time after which the different component needs inspection and maintenance activities is different. To inspect and perform timely maintenance activities, most of the electricity transmission and distribution companies hire many contractors/contractor companies.

Currently, the distribution and transmission companies expect every contractor to be able to perform all kinds of inspection and maintenance works, as the distribution and transmission companies don't have sufficient means to efficiently allocate individual tasks to the most suitable contractor. This increases the costs of the contractors as they need to have a very broad capability of different tasks. This requirement creates a barrier to entry for specialist contractors to the contracting market, and therefore limits the contracting supply available in the market leading to higher costs for distribution and transmission companies.

In addition, the sites for work orders are located at different and also remote sites, it often takes significantly more time to get to the maintenance site than the actual work performed at the site. This increases the maintenance and inspection cost. In addition, as it cost more to the contractor to reach on the maintenance site for only one inspection and/or maintenance job, invariably, all of these maintenance and inspection works cost fixed amount to the transmission or distribution company even if maintenance of some components is cheaper for the contractors.

In addition, currently, the distribution company orders specific work from specific contractor. Once a contractor gets the work order, the contractor goes to the field and performs the specific work order. After the contractor fulfills the work order, the contractor documents the work to a GIS-system and/or to an asset management system and to a system that was used to order the work assignment. The contractor is paid if the work assignment is fulfilled in ordering system even if the documentation requirements of the GIS and asset management system are not fulfilled. The validation that all documentation is completed may be not done at all by the transmission and distribution companies (which can lead to errors in documentation and costly errors and omissions in asset inventory) or the validation is performed manually, which is very costly, slow and error prone.

Further, the contractors work in field very close to other components that may need inspection/repaired/maintenance in the near future. However, these contractors have no knowledge of this. In addition, even if these contractors are aware of the same, they cannot inspect/repair/perform maintenance activities without the consent of distribution and/or company. Furthermore, the contractors have to understand many different systems for work orders and documentation. In addition, most of these systems aren't compatible for portable mobile communication devices which lead to errors and omissions in the documentation level as the documentation cannot be done at the site of work.

In light of the above discussion, there is a need for a method and system which overcomes all the above stated disadvantages and shortcomings.

### BRIEF SUMMARY

In one aspect, embodiments of the present disclosure provide a system for reserving at least one work order using a mobile device with a map view. The system comprises a receiving module, a processing module and a verification module. The receiving module is adapted to receive a request from the mobile device, the request satisfying at least one pre-defined criterion. The processing module is adapted to process the request satisfying the at least one pre-defined criterion by filtering a second set of work orders from a first set of work orders and enable the reservation of each selected work order from the second set of work orders for a pre-defined time period. The verification module is adapted to verify a inspection of each site pertaining to the reserved work orders.

In another aspect, embodiments of the present disclosure provide a method for reserving at least one work order using a mobile device with a map view. The method comprises receiving a request from the mobile device, the request satisfying at least one pre-defined criterion; processing the request satisfying the at least one pre-defined criterion by filtering a second set of work orders from a first set of work orders; reserving each of selected work orders from the second set of work orders for a pre-defined time period; and verifying the inspection of each site pertaining to the reserved work orders.

In an embodiment, the system and the method of present disclosure enable a contractor to reserve work orders of inspection and maintenance of components using a map view on a mobile device. The system and method include filtering possible target sites, associated with work orders, for the contractor on the map view. The possible work orders are filtered based on skill level, equipments possessed by the contractor, and authorization required to fulfill the work order. In addition, the system and method allow selection of geographical area in the map interface by the contractor for choosing the inspection and maintenance jobs. Further, the system and method allow reporting the status of the inspection and maintenance jobs.

In an embodiment of the present disclosure, the system and method enable dynamic pricing where the cost of the maintenance or inspection job of a site at a given time is related to the need of that inspection or maintenance of a particular component at that time. In another embodiment of the present disclosure, the system and method enable verification of the sites inspected by the contractor. In yet another embodiment of the disclosure, the system and method enable the contractor to plan optimal route to their destinations while making stops at components that need inspection and maintenance. Additional aspects, advantages, features and objects of the present disclosure would be made apparent from the drawings and the detailed description of the illustrative embodiments.

It will be appreciated that features of the disclosure are susceptible to being combined in various combinations or further improvements without departing from the scope of the disclosure and this provisional application.

### DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the disclosure is not limited to specific methods and instrumentalities disclosed herein. Moreover, those in the art will understand that the drawings are not to scale. Wherever possible, like elements have been indicated by identical numbers.

FIG. 1 illustrates an environment for practicing various embodiments of the present disclosure;

FIG. 2 illustrates a block diagram of a system for reserving work orders using a mobile device, in accordance with an embodiment of the present disclosure;

FIG. 3 illustrates various components of a mobile device, in accordance with an embodiment of the present disclosure;

FIG. 4 illustrates an example environment for practicing a particular embodiment of the present disclosure;

FIGS. 5-7 illustrate various user interfaces to be provided at a display of a mobile device, in accordance with various embodiments of the present disclosure;

FIG. 8 illustrates a table depicting variation of inspection and maintenance price during a time period, in accordance with an embodiment of the present disclosure;

FIG. 9 also illustrate a user interface to be provided at the display of the mobile device, in accordance with an embodiment of the present disclosure; and

FIG. 10 illustrates a method for reserving at least one work order using a mobile device with a map view, in accordance with various embodiments of the present disclosure.

### DESCRIPTION OF THE PREFERRED EMBODIMENTS

The following detailed description illustrates embodiments of the present disclosure and manners by which they can be implemented. Although the best mode of carrying out the present disclosure has been disclosed, those skilled in the art would recognize that other embodiments for carrying out or practicing the present disclosure are also possible.

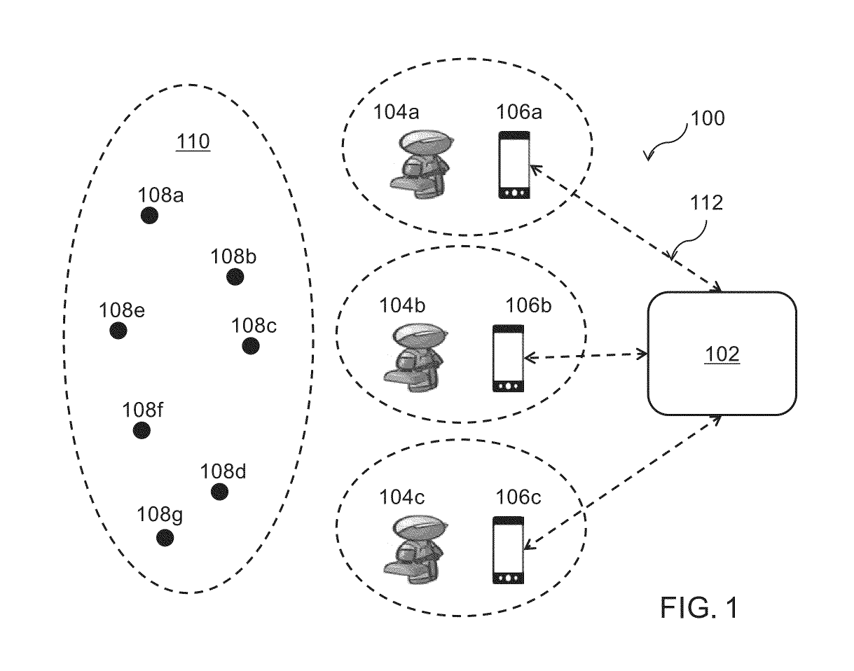

Referring now to drawings, particularly by their reference numbers, FIG. 1 is an illustration of an environment 100, wherein various embodiments of the present disclosure can be practiced. The environment 100 includes a system 102, a plurality of contractors 104a, 104b and 104c (hereinafter collectively referred to as contractors 104) and a plurality of mobile devices 106a, 106b, and 106c (hereinafter collectively referred to as mobile devices 106) associated with contractors 104, respectively. The system 102 and the plurality of mobile devices 106 are communicatively coupled to each other via a communication network 112. In an example, examples of the communication network 112 include, but are not limited to, Internet, Intranet, MAN, LAN, and WAN. The environment 100 also includes a location 110 having a plurality of sites 108a, 108b, 108c, 108d, 108e, 108f (hereinafter referred to as sites 108).

The system 102 enables the contactors 104 to reserve work orders, using the mobile devices 106, associated with various components located in the sites 108. In an example, the location 110 can be an industry and the sites 108 can be various sectors or areas of the industry equipped with various kinds of machines or devices. Therefore, work orders would include tasks associated with the inspection or maintenance activities of such machines or devices.

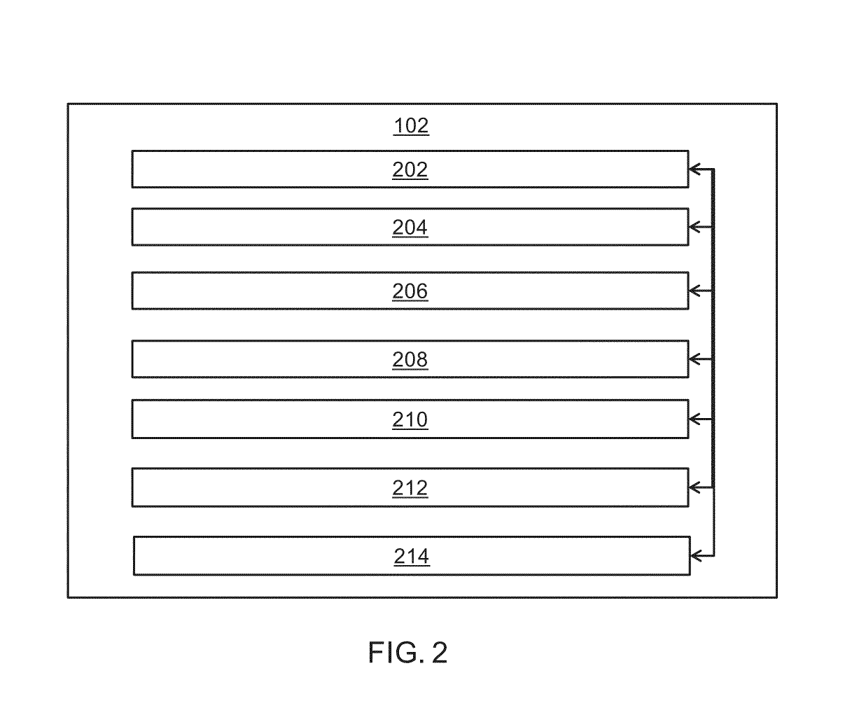

Referring now to FIG. 2, illustrated is a schematic illustration of the system 102, in accordance with various embodiments of the present disclosure. The system 102 includes various modules configured to operate for reserving at least one work order using a mobile device with a map view.

In an embodiment, the system 102 includes a receiving module 202 adapted to receive a request from a mobile device, such as the mobile device 106a, associated with a contractor, such as the contractor 104a. In an example, the request includes a request from the contractor for reserving at least one work order associated a component located at a site, such as the site 108a. Further, the receiving module 202 is operable to receive the requests from the mobile device based on satisfying at least one pre-defined criterion. The pre-defined criterion is selected from a group consisting of equipments needed to perform inspection and/or maintenance related to the work order, skill level needed to fulfill the work order; and authorization required to fulfill the work order. Therefore, when the receiving module 202 receives a request from a mobile device it indicates a contractor associated with such mobile device is capable of being assigned with work orders requested by the contractor.

The system 102 also includes processing module 204 adapted to process the request of work orders from the mobile devices and enable reserving the work orders. In an example, the processing module 204 is configured to process the request (upon satisfying the at least one pre-defined criterion) by filtering a second set of work orders from a first set of work orders. Specifically, the processing module 204 is adapted to select a few work orders (such as the second set of work orders) from a plurality of work orders (from a first set of work orders) based on the request. Typically, a location includes various sites, and each site includes at least one component and each component may be associated with at least one work order. Therefore, the system 102 may accordingly include data or information pertaining to such work orders. The processing module 204 of the system 102 filters a set of work orders from the plurality of work orders based on the request received from the mobile device. The filtered set of work orders is an indication that the contractor is capable of completing tasks or activities associated with the filtered set of work orders.

The processing module 204 of the system 102 further enables in reservation of each selected work order from the second set of work orders for a pre-defined time period. The reservation of each selected work order with the pre-defined time period means reserving or allocating a time period, to each of the selected work order, which is required for completion of the selected work orders. The predetermined period may be expressed in hours or mints depending on the nature of the work order, which in turn may depend on complexity or simplicity of inspection and/or maintenance activities associated with the component.

The processing module 204 of the system 102 is also is operable to plan a route for inspecting at least two sites pertaining to the reserved work orders. For example, when the processing module 204 reserves a set of work orders (pertaining to different sites) based on a contractor's request, the processing module 204 also provides an optimal route to the contractor, i.e. a sequence in which the work orders related to different sites to be attended by the contractor.

In an example, the system 102 helps the contractors to plan a route (as exampled above) to their destinations while making stops at components that need inspection and maintenance. For example the contractor can put a destination (say the site 108a) and tell the mobile device that he needs to be there in three hours and the direct trip would only take an hour with car. Accordingly, the system 102 plans a route for the contractor. This route has other sites (say the site 108b and the site 108c) on which the contractor can inspect and perform maintenance activities and still reach the destination site 180a within three hours. The optimal or planned route optimizes the cost of travelling by the contractor and attending to more work orders upon in a planned manner. This enables the contractor to earn maximum amount of money within the time constraint.

Further, the route considers at least one pre-defined limitation for inspecting at least two sites pertaining to the reserved work orders. For example, the system 102 may provide the route to the contractor based on at least one pre-defined limitation which include but may not limited constraints, such as, equipments needed to perform inspection and/or maintenance related to the work order with the contractor at a given point of time, the skill level needed to fulfill the work order of the contractor, and authorization required to fulfill the work order. For example, if the work is to install new warning sign for substation at a site, such as the site 108a, and the contractor doesn't have warning signs with him, or is not authorized to perform such work, the contractor can filter the map so that it doesn't show those kinds of works. In an embodiment, such criterion is set by the contractors 104. Therefore, the contractor can take a route, which satisfies the time constraints, skill level constraints, tools constraints and the like, while attending to a particular site.

The system 102 further includes a verification module 206 adapted to verify inspection of each site pertaining to the reserved work orders. The verification module 206 is operable to verify the inspection of the sites by the contractors against the reserved work orders.

In an example, the verification module 206 verifies the inspection of a site, by authenticating a scanned unique code of a component on the site. The verification module 206 is adapted to receive the scanned unique code of the component to be transmitted by the mobile device. For example, a contactor uses a mobile device to scan a unique code of a component and thereafter transmit the scanned unique code to the verification module 206. The verification module 206 compares the scanned unique code with a stored unique code for the component. Upon finding a match between the scanned unique code and the stored unique code the verification module 206 verifies the inspection of the site by the contractor.

In another embodiment, the verification module 206 verifies the inspection of a site by authenticating supplementary information of the site provided by the mobile device. For example, the supplementary information can be time-stamped information and the supplementary information can include but not limited to at least one of image of the site, video recording of the site, and measurement data pertaining to a component of the site. Further, the supplementary information can include location information associated with a creation process of the supplementary information.

In an example, the contractor can verify of the inspection or maintenance at a site by sending a photo of the component with the added sign. The sent photo can be coupled with the location information or RFID information to ensure that action is done. The photo, RFID information and alike are defined as the supplementary information. For example, the contractor replaces a sign board on a site. The contractor reads the RFID code on the replaced sign board by the RFID code reader and transmits the information of the RFID code along with the location coordinates and a picture with an added sign clicked by the contractor to the system 102. The system 102 verifies the addition of a replaced sign board by matching the coordinates of the contractor and the coordinates of the site. The performed action may need to be verified and thus authenticated by manually or visually inspecting the supplementary information, or it may be verified automatically. In addition, the system 102 doubly verifies by comparing the time of the presence of the contractor on the site with the point of time when the RFID code reader scanned the particular code of the added sign.

The system 102 of the present disclosure also includes various modules or components to make the system 102 operable for reserving work orders using the mobile device.

Accordingly to an embodiment, the system 102 further includes a sending module 208 operable to transmit information and/or request to the mobile devices 106. In an example, the sending module 208 is capable of transmitting information related to the locations 110 where the contractor 104 can perform inspection or maintenance activities. Moreover, the sending module 208 is operable to transmit information regarding the sites 108 in a location 110 and components that need inspection and maintenance. In another example, the sending module 208 is operable to transmit information regarding the work orders.

The system 102 also includes an updating module 210 operable to update the information related to the system 102. For example, such information includes but not limited information related to all the sites 108 of the location 110, contractors 104, the information related to the mobile devices 106, information related to work orders, the predetermined time period and the pre-defined criterion.

The system 102 also includes a database 212 is adapted to store all the information associated with the system 102. For example, such information includes but not limited to information related to all the sites 108 of the location 110, contractors 104, the mobile devices 106, information related to work orders, predetermined time period and pre-defined criterion.

The system 102 further includes at least one server, such a server 214. The server 214 can be in single location or distributed as cloud service. The service running in the servers 214 can be accessed via a web or mobile application interface by the contractors 104 at any point of time. As an example functionalities/operations related to receiving module 202, processing module 204, verification module 206, sending module 208, updating module 210 and database module 212 can be implemented in the server 214 entirely or partly.

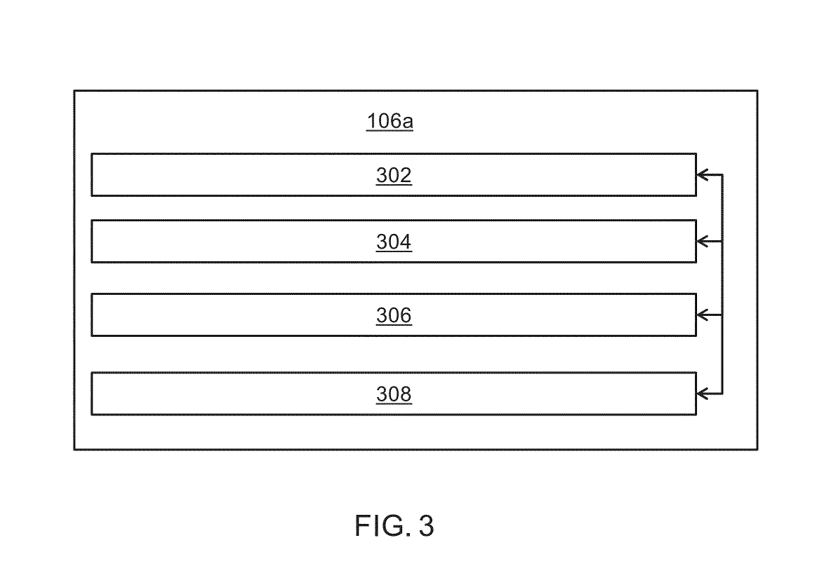

Referring now to FIG. 3, illustrated is a schematic illustration of a mobile device, such as the mobile device 106a, associated with a contractor, such as the contractors 104.

The mobile device 106a includes a control circuitry module 302, a storage module 304, an input/output (“1/0”) circuitry module 306 and a communication circuitry module 308. Examples of the mobile device 106a include but may not be limited to a smart phone, a personal e-mail device (e.g., a Blackberry™ made available by Research in Motion of Waterloo, Ontario), a personal data assistant (“PDA”), a cellular telephone, a Smartphone, a handheld gaming device, a laptop computer, and a tablet computer. Further, the mobile device 106a capable of supporting a map view, specifically a map view of the location 110 having the sites 108. For example, a display of the mobile device 106a capable of displaying the map views thereon.

The control circuitry module 302 includes any processing circuitry or processor operative to control the operations and performance of the mobile device 106a. The control circuitry module 302 is operable to process the information transmitted by the sending module 208 with the help of applications running in the mobile device 106a. In an example, the control circuitry module 302 may be used to run operating system applications, firmware applications, media playback applications, media editing applications, or any other application.

The storage module 304 includes one or more storage mediums including a hard-drive, solid state drive, flash memory, permanent memory such as ROM, any other suitable type of storage component, or any combination thereof. The storage module 304 may store, for example, media data (e.g., music and video files), application data (e.g., for implementing functions on the mobile device 106a). In an example, the storage module 304 is operable to store data related to activities of a contractor 104a, unique codes, photographs, and other related data.

The I/O circuitry module 306 may be operative to convert (and encode/decode, if necessary) analog signals and other signals into digital data. In an embodiment, the I/O circuitry module 306 may also convert digital data into any other type of signal, and vice-versa. For example, the I/O circuitry module 306 may receive and convert physical contact inputs (e.g., from a multi-touch screen), physical movements (e.g., from a mouse or sensor), analog audio signals (e.g., from a microphone), or any other input. The digital data may be provided to and received from the control circuitry module 302, the storage module 304, or any other component of the mobile device 106a.

The mobile device 106a may include any suitable interface or component for allowing a user to provide inputs to the I/O circuitry module 306. The mobile device 106a may include any suitable input mechanism. Examples of the input mechanism include but may not be limited to a button, keypad, dial, a click wheel, and a touch screen.

The communications circuitry module 308 may include any suitable communications circuitry operative to connect to a communications network and to transmit communications (e.g., voice or data) from the mobile device 105 to other devices within the communications network. The communications circuitry 308 may be operative to interface with the communications network using any suitable communications protocol. Examples of the communications protocol include but may not be limited to Wi-Fi, Bluetooth™, radio frequency systems, infrared, LTE, GSM, GSM plus EDGE, CDMA, 3G, and quadband. In an example, the communications circuitry module 308 provides a network for communicating data to and from the system 102.

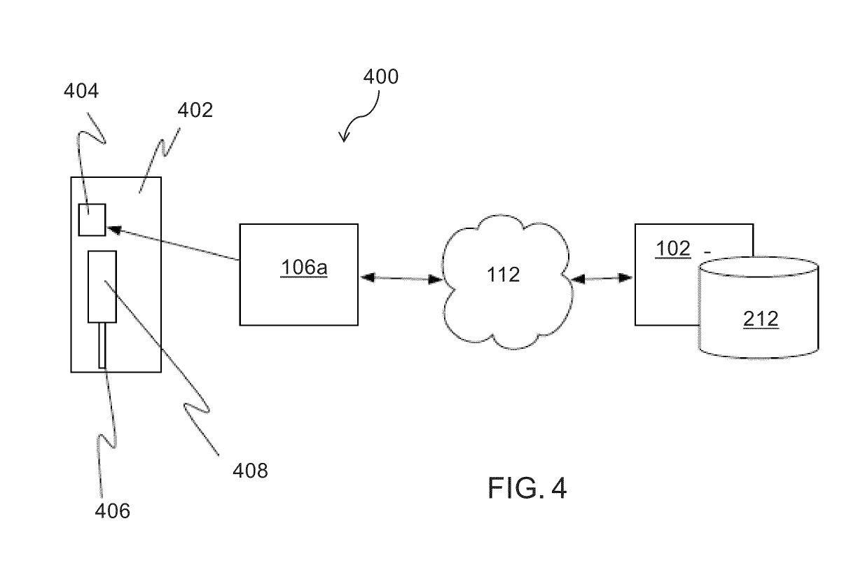

Referring now to FIG. 4, an illustration of an environment 400, wherein an embodiment of the present disclosure is practiced. FIG. 4 shows an example set up of a system 102 enabling inspection and maintenance of a component locates at a site, such as the site 108 using a mobile device, such as the mobile 106a. The system 102 and the mobile device 106a are communicably coupled to each other using a communication network 112. In an example, the component includes a cabinet 402 in the power line network. The cabinet 402 includes a unique identifier 404, such as an RFID tag, a QR code 404, and the like. The cabinet 402 also includes a cable 406 and a fuse 408.

In an example, a work order associated with the cabinet 402 is to inspect the fuse 408. A contractor associated with the mobile device 106a make a request to system 102 for the work order. Upon satisfying at least one pre-defined criterion as explained above, the work order is assigned to the contractor. In the present senior, the pre-defined criterion include equipments, skill and authorization required for performing inspection and maintenance task required for the fuse 408.

Once the work order is selected and reserved with a pre-defined time period (as explained above). The contractor scans the unique identifier 404 with the mobile device 106a. It to be understood that, the mobile device 106a includes appropriate technique such as an RFID reader, a QR code for scanning the unique identifier 404. The scanned unique identifier is communicated to the system 102 for being stored in a database 212. The system 102 particularly a verification module thereof compares the scanned unique identifier with a stored unique identifier for finding a match therebetween to verify inspection of the cabinet 402 pertaining to the reserved work orders. Alternatively, the contractors 104 can send the pictures and/or video (supplementary information of the site) of the inspected cable 406 and the fuse 408 along with his location coordinates for the verification. After verification, the contractor performs the required inspection and/or maintenance task required for the fuse 408.

In an embodiment, the system 102 is configured to make payment to the contractor upon completion of the required inspection and/or maintenance task. For example, when the contractor has completed the task (inspection and/or maintenance task required for the fuse 408) meeting all the obligations, the system 102 initiates the payment process. The system 102 checks the amount to be paid to the contractor and initiates the transaction (associated with the work order). In an embodiment, when the required inspection and/or maintenance task is finished, such information can be sent to a database of a Distribution Company associated with the cabinet 402 of the power line network.

The system 102 of the present disclosure can be practiced using a mobile device with a map view. The map view can be rendered on a display of the mobile device by an application running on the mobile device. The map view is associated with the location having various sites, each site can include at least one components associated with at least one work order.

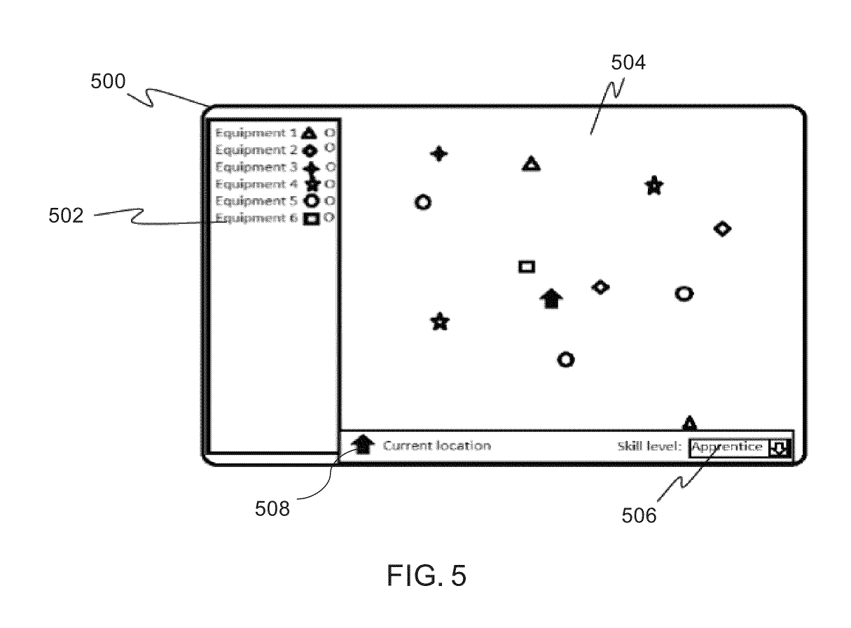

Referring now to FIG. 5, illustrated is an example of a user interface 500 running on a mobile device associated with the contractor. The user interface 500 depicts various functionalities that can be provided by the system 102. The user interface 500 running on the mobile device 106 may be rendered by a stand-alone application, by a web-based application or by a combination of the two. In an example, the user interface 500 includes of an equipment field 502, a map view 504, a skill level menu 506 of the contractor, and a current location 508. The equipment field 502 shows names of maintenance equipment's the contactors 104 has and their respective related symbols. For example, the equipment field 502 has a symbol for a pressure meter carried by the contractors 104.

The user interface 500 provides the map view 504 that shows a map with set of symbols in a top of the map. The symbols in the map show the position of a reserved work order which can be inspected/maintained with the equipments possessed by the contractor. In an example, the map view 504 shows the various components that can be inspected/maintained by the contractors 104 using the pressure meter. Some of the reserved work orders need to be inspected/maintained with multiple equipments. Examples of different type of equipments include but may not be limited to a voltage meter required for (a work order such as) adding/changing a new sign or warning sign, connectors or low voltage switch to replace broken switch, pike for rot measurement (checking the strength periodically) of a pole, adding/changing lock, graffiti removal equipment or having chemicals to remove graffiti, digger to dig a cable out or to dig installation route, chainsaw to cut trees close to power lines, primary or secondary substation keys, cable joint for making connections, earthing measurement equipment to measure resistance of the ground in respect to the power line or power line equipment, climbing irons.

In an embodiment, the map view 504 shows the current location 508 of the contractor. For example, the map view 504 shows that the contractor is at a site, such as the site 108, of a location, such as the location 110. Further, the skill level menu 506 the user interface 500 enables in selecting skill level of the contractor. The map view 504 provides the components that can be inspected/maintained by the contractor based on the skill level. For example, the contractor can be an intern having experience in transformer inspection and maintenance, therefore work orders related to the transformers can be assigned to the contractor (intern).

According to another embodiment, the map view 504 provides an option to the contractor to filter the work orders that he can choose by providing his skill level. For example, contractor can be an intern having experience in transformer inspection would choose work orders related to the transformers.

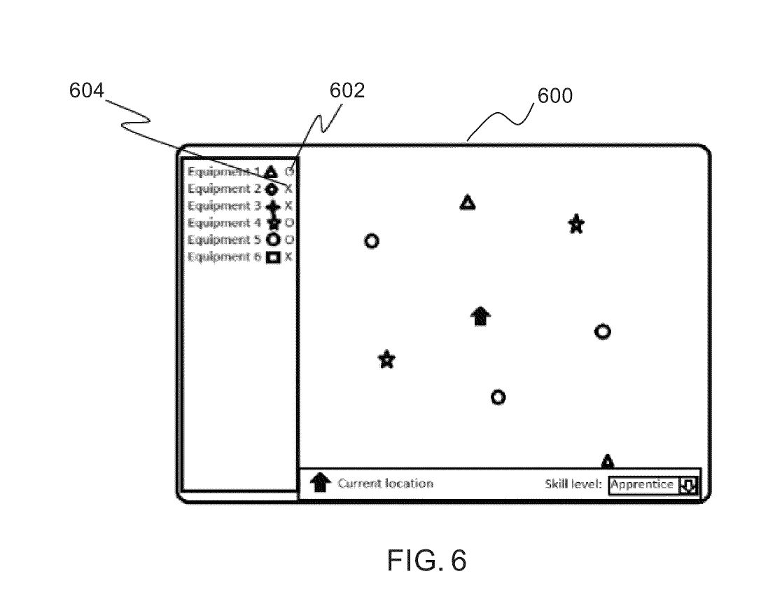

Referring now to FIG. 6, illustrated is an example user interface 600 depicting filtering of the inspection and maintenance of jobs according to the tools possessed by the contractors 104. As shown, the user interface 600 enables a contractor to select from a list of equipments as available 602 or not available 604. For example, the system 102 has a list of equipments which are required by any contractor to perform and inspection of components at a particular site. The contractor selects the equipments possessed by him at a particular time. The system 102 provides a map view of the appropriate sites at mobile device associated with the contractor to perform inspection and maintenance jobs with the possessed equipments. In addition, the map view has pictorial representation of the equipments that will be required at the particular site. Each of the equipment has a corresponding symbol. For example, a voltage meter is represented by a symbol ‘V’ and a pressure meter is represented by a pressure meter ‘P’.

The system 102 filters the sites (along with the work orders) at which the contractor can perform the inspection and maintenance and dynamically provides the map view of the sites to the mobile device after receiving the inputs from the contractor. In an example, the system 102 provides a map view having the sites 108a, 108b on which the contractor can perform the jobs. Each of the filtered sites (the site 108a and the site 108b) is shown with the equipment which the contractor may need to use on the filtered sites. In an example, the site 108a can be shown along with the symbol ‘V’ in the map view. This symbol indicates about the need of that equipment (voltage meter) to perform inspection and maintenance at the site 108a. In other words, the contractor can filter the work orders based on the equipment he or she possesses.

Additionally, the map view of the location enables the contractors to easily spot nearby components on different the sites, that need inspection and maintenance. In an embodiment, each of the contractors downloads a mobile based application on their respective mobile devices, which enables the interaction of the system 102 with these mobile devices and provides the map spotting nearby components. In an embodiment, the map provided to each of the contractors has all nearby components theme colored or indicated by various symbols by the need of maintenance. For example, the system 102 provides a map on the mobile device 106a (associated with the contractor 104a) with theme colored components which need the inspection. Therefore, the contractor can earn maximum amount of money in a time frame when he/she will inspect these components. On the same lines, the system 102 may provide a map on the mobile device with theme colored components which need the inspection.

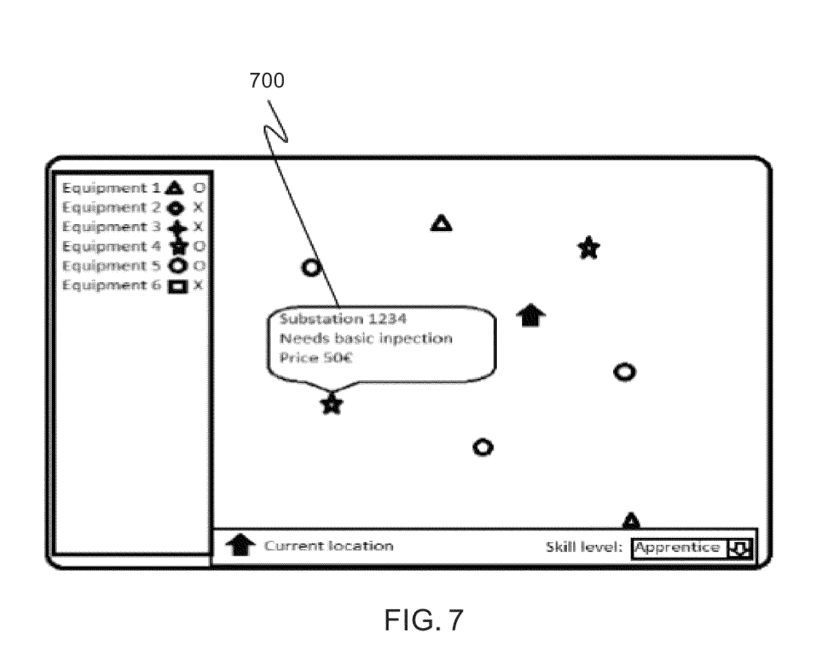

Referring now to FIG. 7, shows is an example of information 700 related to a target site viewed by the contractor in the map view. In an embodiment, the contractor views the information in the map view on the mobile device by using a pointer/or touching a finger on the component (say on the site 108a) in the map view. The contractor can select any work order to see pictures, price and general information of the object. For example, the contractor can view all the information related to any the site 108a by using a pointer on the map view on the mobile device. As shown in the FIG. 7, the information 700 includes name of the target such as “a substation 1234” and the information related to work order “Needs basic inspection”, and “a price of the basic inspection”. It may be noted that the information 700 shown is only for the illustrative purposes and should not be construed as limiting the scope of the disclosure. For example, the price of the inspection can be variable and depended on the timing. Specifically, if the inspection is not due for a while, the price can be different from the scenario where the inspection should be done immediately. If there is mandatory requirement to inspect the substation 1234 every 12 months after previous inspection, the price of the inspection can be adjusted to take in consideration the time aspect.

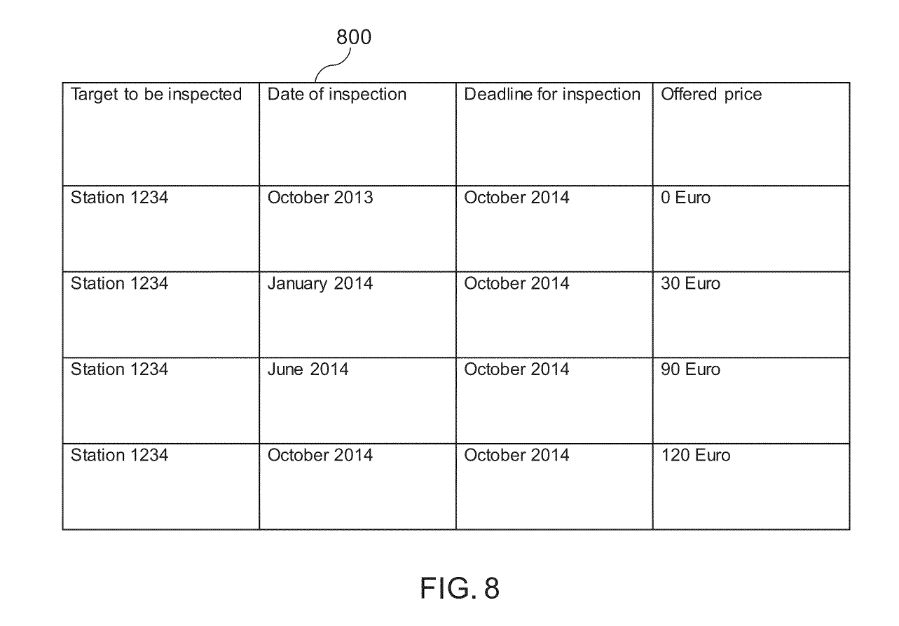

Referring now to FIG. 8, shows is a table 800 providing an example of the variation of the price of the inspection with the time period. In an example, the site 108a has a substation inspected in October 2013 and the next deadline for the inspection is after one year (October 2014). The price to inspect the transformer in October 2013 is zero Euros as it does not change the fact that the station has to be inspected in 12 months of time. On the other hand, if the inspection is done close or at the dead line of October 2014, the price can be for example 120 Euro. Similarly, if the inspection is done in June 2014, the next inspection after said inspection would be in June 2015, thereby postponing the inspection 9 months and at a price of 90 Euros. In other words, if the contractor chooses to inspect the site (the substation 1234) in June 2014, he may be offered 90. Euros. In addition, once the contractor inspects the site (the substation 1234), the next deadline of the inspection of the site will be set as June 2015. In an embodiment, an administrator of the system 102 provides the table 800 in consultation with the appropriate decision makers such as the Distribution Company and/or Transmission Company.

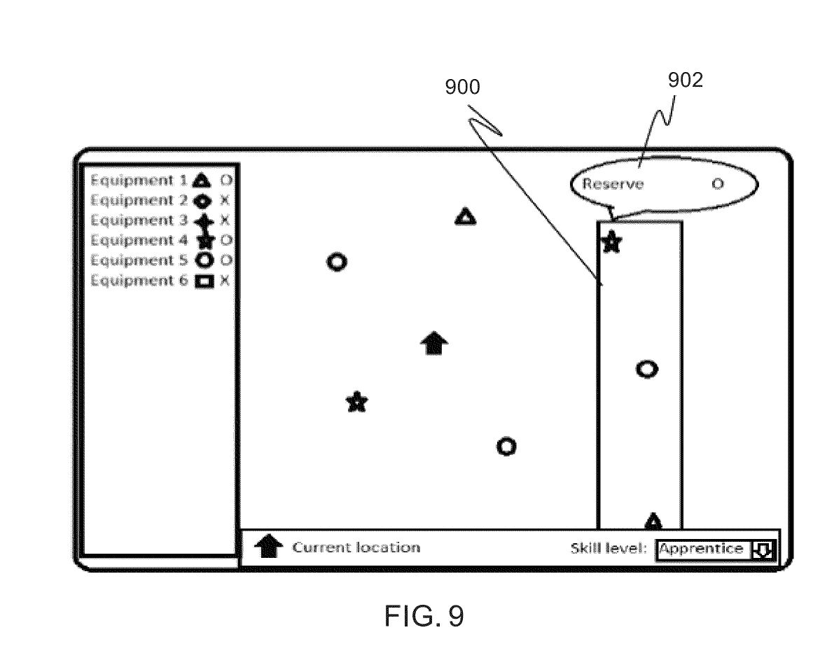

FIG. 9 shows another view of the user interface for collecting the information of different sites, such as the sites 108. In an embodiment, as shown in FIG. 9, the contractor can select an area 900 with user interface by defining a square or free hand drawing or selecting all components in a view. The contractor is presented with a menu 902 to reserve the target to perform the work. For example, a contractor reserves the inspection and maintenance of a site by accepting the price and other criteria provided in the map view. In an embodiment, the system 102 includes a predetermined time period of the reservation. For example, a site is reserved for 24 hours by a contractor to complete the tasks he has committed to do in the site. If the contractor does not report said actions done by end of the reservation time, the site will be free or can be reserved by other contractors. In an embodiment, if a contractor systematically fails to deliver the orders, the system 102 reduces reservation time or to limit area, which the contractor has reserve or to limit the usage of the system 102 temporarily or permanently by the contractor. Also, if the contractor does not complete the work orders on a pre-determined, the contractor loses his reservation rights for certain period of time. In an embodiment, the administrator of the system 102 can change the conditions of reservation and/or cancellation of the reservation in consultation with appropriate decision makers such as Distribution Company and/or Transmission Companies.

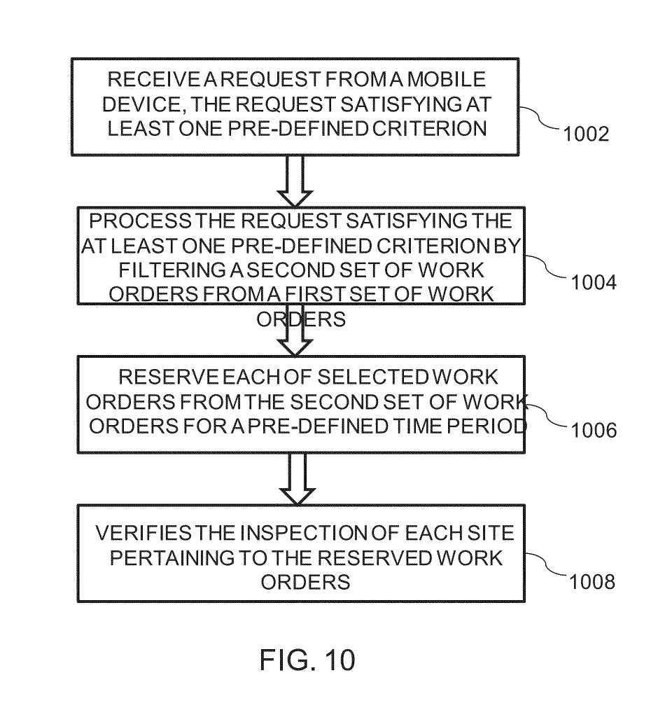

Referring now to FIG. 10, illustrated is a method 1000 for reserving at least one work order using a mobile device with a map view, in accordance with another embodiment of the present disclosure.

At step 1002, a request is received from a mobile device. The request satisfies at least one pre-defined criterion. In an example, the pre-defined criterion various aspects includes but not limited to equipments needed to perform inspection and/or maintenance related to a work order, skill level needed to fulfill the work order, and authorization required to fulfill the work order.

At step 1004, the request is processed satisfying the at least one pre-defined criterion by filtering a second set of work orders from a first set of work orders.

At step 1006, each of selected work orders from the second set of work orders is reserved for a pre-defined time period.

At step 1008, inspection of each site pertaining to the reserved work orders is verified. In an example, the verification of the inspection of a site performed by authenticating a scanned unique code of a component on the site transmitted by the mobile device by comparing it with a stored unique code for the component of the site. Alternatively, the verification of the inspection of a site is performed by authenticating supplementary information of the site provided by the mobile device. The supplementary information is time-stamped and includes at least one of image of the site, video recording of the site, and measurement data pertaining to a component of the site. Further, the supplementary information includes location information associated with a creation process of the supplementary information.

It should be noted here that the steps 1002 to 1008 are only illustrative and other alternatives can also be provided where one or more steps are added, one or more steps are removed, or one or more steps are provided in a different sequence without departing from the scope of the claims herein.

For example, the method 1000 further includes processing the request to plan a route by taking into account at least one pre-defined limitation for inspecting at least two sites pertaining to the reserved work orders. The planned route optimizes the cost of travelling taking into account the at least one pre-defined limitation.

The system 102 and the method 1000 of the present disclosure enable a contractor with different level of expertise and equipments to attend the work orders. For example, the system provides a map view which shows that a contractor can inspect and maintain components of a site on his way to another site, within the given time constraint, when the contractor often visits another site located after the site. Further, the system enables the contractors to figure out on what equipments they should invest so as to perform work orders that they couldn't previously perform.

In an embodiment, the system 102 and the method 1000 provide a dynamic pricing model for a distribution and/or the transmission companies to be offered to the contractors. The dynamic pricing model is dependent on the need of the repair or inspection of components located at the different sites. In an example, if one component group A located at a site needs to be inspected every 6 years. In such instance, if the last inspection for this component group A is performed 6 years ago, the price of that inspection is a standard inspection price (600 Euros). However, if the component group A was inspected 4 years ago, the price of that inspection is reduced (300 Euros, half of the normal price). Further, if the component group A are inspected more frequently than every 6 years, the overall cost of inspection is lower than with the old pricing method, thereby benefiting the distribution company and/or transmission component. Further, the pricing model can be self-adjustable so that it can change the inspection prices between different work orders located at different sites in order to make sure that all or nearly all work orders are inspected within a predetermined time period. For example, when a price of the work (i.e. offered price to complete the work) and a cost of the work (i.e. cost incurred by the contractor to complete the work) don't match, the system automatically adjust prices to match the costs.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

1. A system for reserving at least one work order using a mobile device with a map view, the system comprising:
a receiving module adapted to receive a request from the mobile device, the request satisfying at least one pre-defined criterion;
a processing module adapted to:
process the request satisfying the at least one pre-defined criterion by filtering a second set of work orders from a first set of work orders; and
enable the reservation of each selected work order from the second set of work orders for a pre-defined time period; and
a verification module adapted to verify inspection of each site pertaining to the reserved work orders.

2. The system as recited in claim 1, wherein the pre-defined criteria is selected from the group consisting of:
equipments needed to perform inspection and/or maintenance related to the work order;
skill level needed to fulfill the work order; and
authorization required to fulfill the work order.

3. The system as recited in claim 1, wherein the verification module verifies the inspection of a site by authenticating a scanned unique code of a component on the site transmitted by the mobile device by comparing it with a stored unique code for the component of the site.

4. The system as recited in claim 1, wherein the verification module verifies the inspection of a site by authenticating supplementary information of the site provided by the mobile device.

5. The system as recited in claim 4, wherein the supplementary information is time-stamped and the supplementary information comprises at least one of image of the site, video recording of the site, and measurement data pertaining to a component of the site.

6. The system as recited in claim 4, wherein the supplementary information further comprises location information associated with a creation process of the supplementary information.

7. The system as recited in claim 1, wherein the processing module is further adapted to plan a route taking into account at least one pre-defined limitation for inspecting at least two sites pertaining to the reserved work orders.

8. The system as recited in claim 7, wherein the planned route optimizes the cost of travelling taking into account the at least one pre-defined limitation.

9. The system as recited in claim 1, wherein the map view is rendered on a display of a mobile device by an application running on the mobile device.

10. A method for reserving at least one work order using a mobile device with a map view, the method comprising:
receiving a request from the mobile device, the request satisfying at least one pre-defined criterion;
processing the request satisfying the at least one pre-defined criterion by filtering a second set of work orders from a first set of work orders;
reserving each of selected work orders from the second set of work orders for a pre-defined time period; and
verifying inspection of each site pertaining to the reserved work orders.

11. The method as recited in claim 10, wherein the pre-defined criteria is selected from the group consisting of:
equipments needed to perform inspection and/or maintenance related to the work order;
skill level needed to fulfill the work order; and
authorization required to fulfill the work order.

12. The method as recited in claim 10, wherein the verification comprises the inspection of a site by authenticating a scanned unique code of a component on the site transmitted by the mobile device by comparing it with a stored unique code for the component of the site.

13. The method as recited in claim 10, wherein the verification further comprises the inspection of a site by authenticating supplementary information of the site provided by the mobile device.

14. The method as recited in claim 13, wherein the supplementary information is time-stamped and the supplementary information comprises at least one of image of the site, video recording of the site, and measurement data pertaining to a component of the site.

15. The method as recited in claim 13, wherein the supplementary information further comprises location information associated with a creation process of the supplementary information.

16. The method as recited in claim 10, wherein the processing is further adapted to plan a route by taking into account at least one pre-defined limitation for inspecting at least two sites pertaining to the reserved work orders.

17. The method as recited in claim 16, wherein the planned route optimizes the cost of travelling taking into account the at least one pre-defined limitation.

18. The method as recited in claim 10, wherein the map view is rendered on a display of a mobile device by an application running on the mobile device.
